(19) United States
(12) Patent Application Publication
(10) Pub. No.: US 2009/0125320 A1
(43) Pub. Date: May 14, 2009

(54) METHOD AND SYSTEM FOR DISPLAYING BUSINESS INFORMATION

(76) Inventor: Erick J. Bickett, Yorba Linda, CA (US)

Correspondence Address: STETINA BRUNDA GARRED & BRUCKER, 75 ENTERPRISE, SUITE 250, ALISO VIEJO, CA, 92656, US

(21) Appl. No.: 12/061,002

(22) Filed: Apr. 2, 2008

Related U.S. Application Data
(60) Provisional application No. 60/987,383, filed on Nov. 12, 2007.

(51) Int. Cl. G06Q 99/00

(52) U.S. Cl. 705/1

(57) ABSTRACT

The method begins by storing a set of business information in a database. The database contemplates storing business information for a plurality of businesses. The method continues with collecting customer satisfaction information related to the plurality of businesses. The collected customer satisfaction information is inputted into the database. Additionally, the inputted customer satisfaction information is correlated to the plurality of businesses. The method continues with receiving a search query. In response to receiving the search query, the method contemplates generating a responsive data subset. The method also contemplates displaying the sorted data subset on a webpage.

### CROSS-REFERENCE TO RELATED APPLICATIONS

The present application claims priority to U.S. Provisional Application No. 60/987,383, filed Nov. 12, 2007.

### STATEMENT RE: FEDERALLY SPONSORED RESEARCH/DEVELOPMENT

Not Applicable

### BACKGROUND

1. Technical Field

The present invention relates generally to providing a listing of businesses in response to a user search query and, more particularly, to a listing of businesses in the order of geographical proximity to the location provided in response to the user search query and verified customer feedback information corresponding to each business listed.

2. Related Art

With the emergence of the Internet as a global juggernaut for advertising and marketing, review sites have become a very powerful consumer tool. Review sites allow the consumer to choose a particular product, service, or business based upon reviews and ratings earned by a particular product or service. There are product review websites that provide reviews of consumer products, including consumer electronics, appliances, automobiles, books, compact discs, wines, etc. There are also service provider review sites that provide reviews of individual professionals, such as teachers, professors, lawyers, accountants, realtors, or doctors by way of example. Additionally, there are business review websites that provide reviews of premise-based businesses, such as restaurants, childcare facilities, hotels, or apartment buildings.

However, most review sites make little or no attempt to restrict postings, or to verify the information in the reviews. In some instances, positive reviews are often written by the businesses or individuals being reviewed. Alternatively, some negative reviews may be written by competitors, disgruntled employees, or anyone with a grudge against the business being reviewed. Furthermore, studies of research methodology have shown that in forums where people are able to post opinions publicly, group polarization often occurs. As a result of group polarization the reviews typically include very positive comments, very negative comments, and a dearth of comments ranging in between the positive and negative comments, meaning that those who would have been in the middle are either silent or pulled to one extreme or the other. Furthermore, those review sites that rely on income from participating businesses that are being reviewed are reluctant to post negative reviews since that may undermine their business model and lead to a conflict of interest.

A popular rating and review system well known in the art include those used on travel websites. For example, a person searching for a hotel in a particular destination may enter a search query at the travel website. The person may enter a destination via a web browser in communication with the travel website and a listing of hotel sights is provided as a result. Corresponding to each hotel there may be a rating and a link that may lead to a plurality of reviews. The person may also choose to have the hotels listed based on ratings and reviews provided by customers who have stayed at the hotels. The ratings may be based on a point system whereby the reviewer provides a number representative of their satisfaction with the hotel. The point system is representative of a customer satisfaction score. These ratings are then averaged or implemented into an algorithm and the hotel with the higher score is typically looked upon more favorably on the list of hotels provided. Furthermore, reviews from various customers in the form of customer testimonials may be read that provide more detail and insight as to why a hotel received a certain rating or why the hotel received a poor rating. However, this system is fraught with the problems discussed above.

Another industry wherein customer review and ratings may prove integral when a potential customer seeks a service is the automobile repair industry. Many people are weary of finding an automobile repair shop that they can trust. In the automobile repair industry it is highly probable that many consumers have had a bad experience or possibly been a victim of fraud as a result of visiting an automobile repair shop. A review site may provide the consumer with confidence when searching for an automobile repair business. The consumer may access the review site to see what other people have said about a particular automobile repair business. In this way, the consumer can eliminate any potentially troublesome businesses that have received bad ratings from unsatisfied customers. Alternatively, the consumer may find an automobile repair business with great reviews and thus more likely to visit that business for a particular service or product. Thus, potential consumers seek customer satisfaction information and testimonials that will enhance customer confidence in the service being offered. The potential customers need a trustworthy review that is less susceptible to the problems associated with review sites as discussed above.

Accordingly, there exists a need in the art for a method and system for displaying business information as it relates to customer satisfaction information that is verified and audited. This need is addressed by the present invention, as will be described in more detail below.

### BRIEF SUMMARY

In accordance with one embodiment of the present invention, there is provided a method and system for displaying business information. The method begins by storing a set of business information in a database. The business information stored in the database may include the business address, contact information, and other information related to a business. The database contemplates storing business information for a plurality of businesses. Therefore, the exemplary type of business information described above is stored in the database for the plurality of businesses. The method continues with collecting customer satisfaction information related to the plurality of businesses. The collected customer satisfaction information relates to the experience the customer had with a business from the plurality of businesses. An aspect of the invention contemplates communicating with the customer via telephone or email in order to obtain the customer satisfaction information. In another embodiment of the present invention, the customer may provide customer satisfaction information via a survey completed on a web browser and transmitting the survey responses to the database. The collected customer satisfaction information is inputted into the database. Additionally, the inputted customer satisfaction information is correlated to the plurality of businesses. Thus, the customer satisfaction information provided by a customer is matched to the business from the plurality of businesses that provided a service or product to the customer.

The method continues with receiving a search query. The search query is contemplated to be a geographic location. For example, the search query may be a zip code, an address, or an area code. In response to receiving the search query, the method contemplates generating a responsive data subset. The responsive data subset may include a list of businesses from the plurality of businesses that meet a geographic proximity requirement. For example, all businesses within 100 miles of the location inputted into the search query may be listed from the plurality of businesses. The data subset is sorted in order of at least geographic location information. The method also contemplates displaying the sorted data subset on a webpage. The sorted data subset represents a list of businesses from the plurality of businesses. Further, for each business listed in the sorted data subset corresponding customer satisfaction information is included. In one embodiment, it is contemplated a web server receives the search query via the web browser. The web server may also include a software application for generating the responsive data subset. The software application may also be configured to sort the data subset using at leas geographic location information. The software application is contemplated to format the sorted data subset for display on a webpage hosted by the web server. An aspect of the present invention contemplates the database being hosted on the web server. Alternatively, the database may be remotely located from the web server.

In yet another embodiment of the present invention, a system for displaying business information is provided. The system includes a database for storing a set of business information. The business information relates to a plurality of businesses. The database of the system is also configured to store customer satisfaction information. The system also includes a software application hosted on the database. The software application is configured to collect customer business information from the plurality of businesses. The system further includes a web server. The web server receives the search query from a web browser. In response to receiving the search query, the web server generates a data subset. The data subset generated is representative of a list of businesses from the plurality of businesses. The data subset may include customer satisfaction information corresponding to each business within the list of businesses. Importantly, the web server is also configured to sort the data subset using at least geographic location information.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart diagram illustrating the customer feedback mechanism in accordance with the present invention;

FIG. 2 is a flow chart diagram in accordance with the present invention;

FIG. 3 is a screenshot of a search query webpage in accordance with the present invention;

FIG. 4 is a screenshot of a business listing webpage in accordance with the present invention; and

FIG. 5 is a webpage displaying a participating business in accordance with the present invention.

### DETAILED DESCRIPTION

The above description is given by way of example, and not limitation. Given the above disclosure, one skilled in the art could devise variations that are within the scope and spirit of the invention disclosed herein, including various ways of displaying business information. Further, the various features of the embodiments disclosed herein can be used alone, or in varying combinations with each other and are not intended to be limited to the specific combination described herein. Thus, the scope of the claims is not to be limited by the illustrated embodiments.

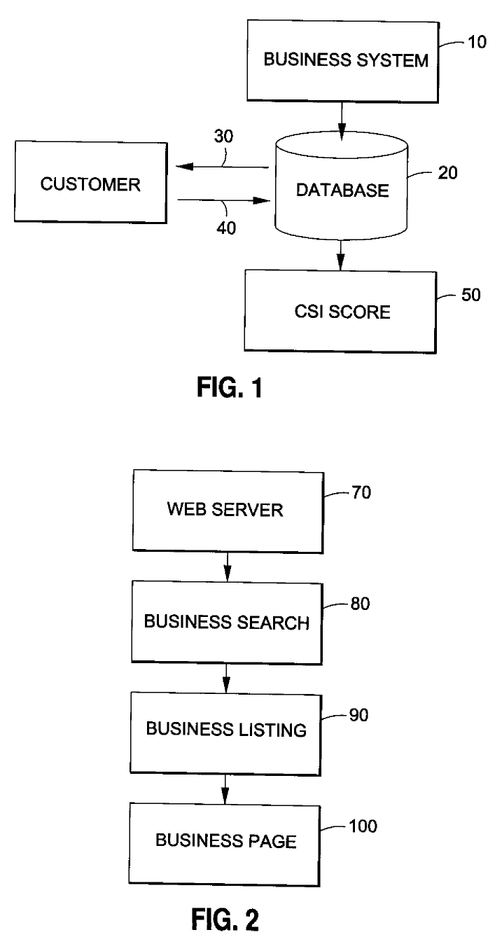

With reference to FIG. 1, a flow chart representative of a customer feedback mechanism for receiving customer feedback information is illustrated. The first block associated with the customer feedback mechanism is a business system 10. The business system 10 includes a data transmission software program. The data transmission software program is installed at every participating business affiliated with an independent provider of a review or rating website. The business system 10 via the data transmission software program is configured to transmit business information representative of a transaction between a customer of the participating business and the participating business. It is contemplated that the transaction is for a product or service offered by the participating business. The business system 10 may be configured to transmit business information for every transaction between the customer and the participating business. This is important because it prevents the participating business from screening the business information to a centralized database 20 hosted by the independent provider. For example, the participating business may attempt to only transmit business information for transactions with customers that the business believes will provide positive customer feedback. Alternatively, the business system 10 prevents the participating business from not transmitting or screening any transactions with customers that the participating business believes will provide negative feedback. Thus, the business system 10 stored at each participating business helps preserve the integrity of the review and rating method and system provided by the independent provider. Additionally, the business system 10 ensures that every business transaction between a plurality of customers and a plurality of participating businesses is transmitted to the central database 20 hosted by the independent provider.

The business system 10 may also be configured to transmit business information to the database 20 immediately after the transaction is recorded with the business system 10 at the participating business. In this respect, the database is continuously and automatically updated with new transactions as soon as the transaction is recorded within the business system 10 installed at the plurality of participating businesses. The business information transmitted from the business system 10 to the database 20 may include customer contact information such as a phone number or an email. It is also contemplated that the business information provides details regarding the service rendered or the product provided as a result of the transaction between the customer and the participating business. The business system 10 provides sufficient information to obtain accurate and audited feedback from the plurality of customers. With the information provided, the service or product provided may also be categorized to further refine the review and rating method and system. Such a comprehensive amount of business information translates into a more robust, verifiable, and trustworthy rating system.

Still referring to FIG. 1, the centralized database 20 is hosted by the independent provider. For a business to be included within the centralized database, the business must register with the independent provider. The registration process may ensure that the participating business has the business system 10 installed at their location to prevent screening for only positive customer feedback reviews and testimonials. The database 20 stores the business information transmitted by the plurality of participating businesses utilizing the business system 10. The database 20 also stores information about each participating business from the plurality of participating businesses. For example, the information stored in the database 20 about each participating business may include a business address, the business contact information, name of the business, the type of services or products provided by the business, etc. The database 20 is configured such that upon receiving business information from the business system 10 of the participating businesses, the business information for each business is matched with the participating business stored within the database 20. This guarantees that the transactions between the plurality of customers with the plurality of participating businesses are stored in the database 20 under the appropriate participating businesses. In other words, the transactions of the plurality of customers associated with one of the participating businesses are stored in the database 20 corresponding to the participating business. This is repeated for every participating business from the plurality of participating businesses.

The database 20 may also be configured to contact 30 the plurality of customers and obtain feedback 40 about their service experience or the product provided in order to include testimonials and generate an overall customer satisfaction index score 50 for each participating business. In one embodiment of the present invention, the database 20 utilizes a service provider to contact 30 the plurality of customers and obtain feedback 40. An aspect of the present invention contemplates that the customers are contacted 30 via telephone to obtain their testimonials and feedback. However, it is also contemplated that email may be utilized to contact 30 the plurality of customers and obtain customer testimonials and feedback information 40. These methods prevent group polarization, because the customer providing feedback is not exposed to the reviews, ratings, or testimonials provided by other customers. Further, these methods are used to verify and audit that the customer received a service or product. This prevents phony or fake customer testimonials and ensures that the customer feedback information is authentic. In another embodiment, the customer feedback may be provided via a website, where the customer initiates a communication link with the database 20 utilizing a web browser. In this respect, it is contemplated that each customer is contacted for providing feedback and satisfaction information about the product or service purchased from the participating businesses. An aspect of the present invention contemplates the service provider initiating a communication with the customer in response to receiving the business information in the database 20. The customer feedback 40 provided is then recorded and stored within the database 20 and matched to the appropriate participating business involved in the transaction with the customer that provided the feedback information 40. It is contemplated that an attempt to contact every customer of the plurality of participating businesses stored in the database is made to obtain the customer satisfaction information 40. In this respect, the method and system allows for a collection of large inventory of customer satisfaction information to be associated with each participating business from the plurality of participating businesses.

Still referring to FIG. 1, following the database 20 receiving customer satisfaction information 40, the information is converted into the customer satisfaction index (CSI) score 50. The CSI score 50 is calculated by the centralized database 20. The customer feedback information is used to calculate the CSI score 50 for each participating business. For example, the database 20 may include customer feedback information for one hundred customers for one participating business from the plurality of participating businesses. If eighty customers gave positive reviews and twenty customers gave negative reviews, the customer satisfaction index score 50 is 80%. Based upon this percentage, a potential customer of the participating business would know that 80% of the business's customers were satisfied with the service or product they received and recommend the business. It is also contemplated that the CSI score 50 calculated by the database 20 may be representative of the customer feedback information within a certain time period rather than using a total as described in the previous example. For example, the CSI score 50 may be calculated for received customer feedback information 40 provided in the last thirty days. Thus, a potential customer may notice if the service provided by the participating business has improved recently or whether the customer satisfaction index score 50 has decreased. A business with a higher customer satisfaction index score 50 is more likely to instill greater consumer confidence because of its praise from customers who have provided feedback information in a verified and audited method and system.

Referring now to the flow chart of FIG. 2, the method and system contemplates the database 20 being hosted on a web server 70. The web server 70 of the independent review site provider hosts a website including web pages for displaying information that may provide a potential customer of the plurality of participating businesses greater confidence when choosing a business for a service or product. The web server 70 includes a software application to format the information within the database 20 for display on the website. The software application formats the information to be accessible to a potential customer through the use of a web browser. In particular, the software application is configured to format the information stored within the database 20 including customer feedback information 40, CSI score 50, and information corresponding to the plurality of participating businesses on a webpage that is suitable for access by a web browser. An aspect of the present invention contemplates that the information in the database 20 is formatted in HTML or XHTML format for display on the webpage of the website hosted by the web server 70. The webpage may be formatted such that there are hypertext links providing navigation to other web pages on the website or different websites such as those hosted by the plurality of participating businesses.

The next step contemplates a business search 80. A user or potential customer searching for a product or service conducts the business search 80. The business search 80 is conducted at the webpage of the website hosted by the web server 70. The first step includes initiating a communication link between the user's web browser and the web server 70. In one embodiment it is contemplated that the user via the web browser, enters the uniform resource locator (URL) for the website hosted by the web server 70. In another embodiment, it is contemplated that the user is led to the business search 80 web page after conducting a general search within an internet search engine. For example, if the user is looking for an automobile repair shop, the user may type the key words associated with an automobile repair shop in an internet search engine such as google, yahoo, or msn for example and not of limitation. The search engine then may return a list of results, one of the results may be a hypertext link to the website and more specifically to the webpage hosted by the web server 70. In response to the initiation of the communication link between the user's web browser and the web server 70, the web server may serve an HTTP response consisting of a webpage typically represented by an HTML document and linked objects.

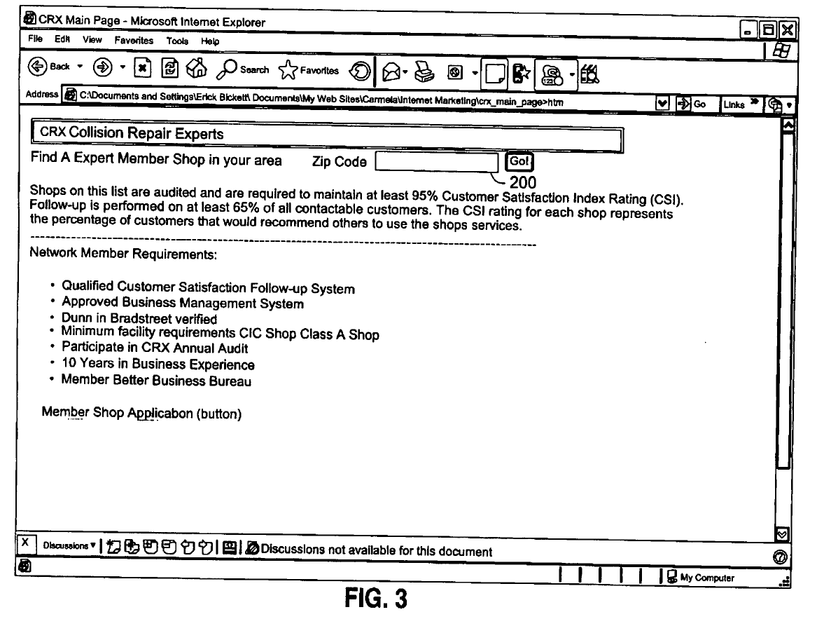

Referring briefly to FIG. 3, a screenshot of the webpage displayed on the user's web browser in response to initiating the communication link between the user's web browser and the web server 70 is shown. The webpage is where the business search 80 is conducted. The webpage displayed on the user's web browser transmitted from the web server 70 includes a search information query or request box 200. The search information query is represented by the location on the webpage requesting a zip code 200. The zip code 200 is representative of the location in which the user is searching for the participating businesses. However, it is contemplated that other search information may be requested including an address or an area code. The user may provide an address or an area code in the search information query box 200 wherein the user can expect a list of businesses within a certain distance from the location provided by the user.

In response to the user responding to the search query, the information inputted by the user into the query search box 200 is transmitted to the web server 70. For example, if the user inputs a zip code, address, or area code this information is transmitted to the web server 70. The software application hosted on the web server 70 is configured to generate a list of businesses from the plurality of businesses within a certain distance from the location provided by the user through the business search 80. It is contemplated that the software application may sort the business listing 90 in order of geographical proximity to the inputted information provided in the business search 80 by the user. In another embodiment of the present invention, the business listing 90 may be sorted based upon the customer satisfaction index score 50 of participating businesses within a certain proximity to the location provided by the user. Thus, the software application hosted on the web server 70 responds to the user search information to sort the business listing 90 for display on the user's web browser tailored to the location the user provided in the query box 200.

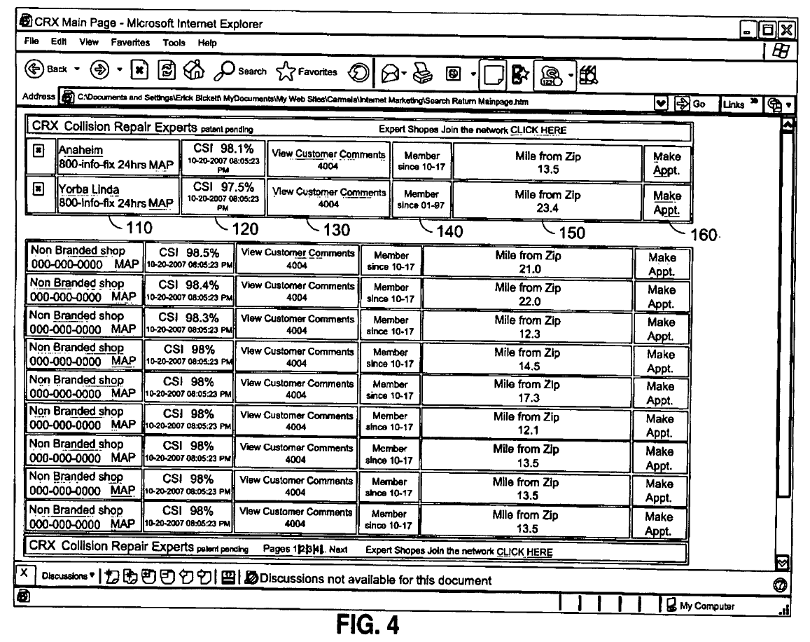

Referring now to FIG. 4, a screenshot of the business listing 90 generated by the software application hosted by the web server 70 is shown. The business listing 90 displayed by the screenshot is only one example of the various possibilities in which the business listing 90 may be displayed. The business listing and the resource of information may be displayed in a plurality of columns and rows. In this embodiment of the present invention, each row may be representative of a participating business from the plurality of participating businesses. The columns include business information and information related to the customer feedback for the participating businesses listed. The first column 110 displayed in the business listing includes the name of the business, a phone number and a hypertext link for navigating the user's web browser to a webpage displaying a map of where the business is located. The business name provided may be in the form of a hypertext link configured to navigate the user's web browser to a webpage or website hosted by the participating business. Additionally, the map may illustrate a path from the location provided by the user to the business. In the second column 120, the customer satisfaction index score 50 based upon the customer feedback information may be displayed. Additionally, a date and time may be provided along with the CSI score 50 so that a potential customer viewing the CSI score 50 associated with the participating business can determine how current the CSI score 50 is. The third column 130 may include a hypertext link configured to navigate the user's web browser to a webpage on the website that displays customer comments for the participating business. The customer comments are testimonials provided by the customer when contacted by the service provider to obtain the customer feedback information. The third column 130 may also display the number of comments available if the hypertext link is followed. A fourth column 140 may indicate the date when the participating business first became a member associated with the review site hosted by the independent provider. The fifth column 150 may include the distance the participating business is from the location provided by the user. In one embodiment, it is contemplated that the business listing 90 is sorted by distance. This may allow the user or potential customer to determine which participating business is closest to the location provided by the user and has a corresponding CSI score 50 the user is comfortable with. The sixth column 160 may include another hypertext link guiding the user's web browser to a webpage for scheduling an appointment with the participating business.

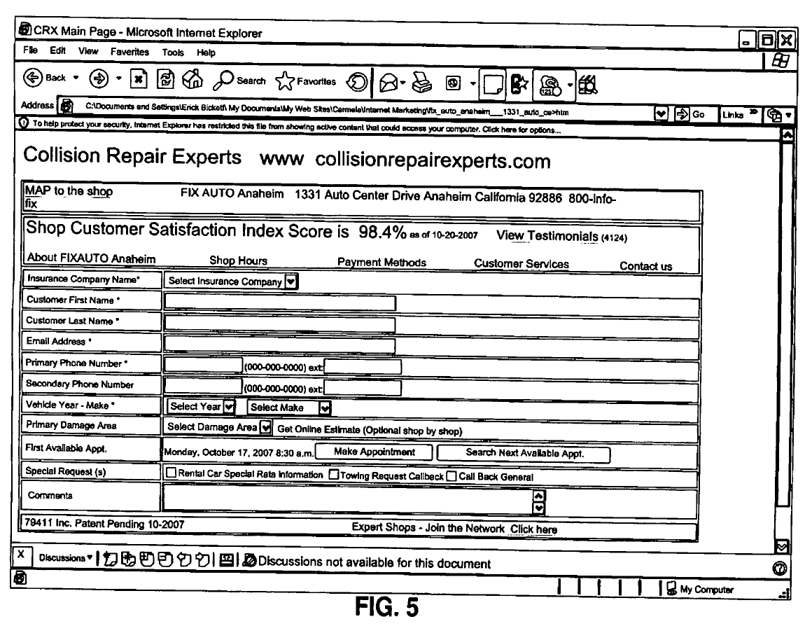

In another embodiment of the present invention, the web sited hosted by the web server 70 includes a webpage displaying a multitude of customer testimonials for the participating business selected from the business listing 90 page. For example the user may be provided with the option of being navigated to a webpage by selecting the hypertext link associated with viewing customer testimonials 130 from a plurality of customers of the business selected. The user may then view customer testimonials in regard to the service or product the customers received from the participating business. Referring briefly now to FIG. 5, another screenshot is illustrated. FIG. 5 is illustrative of a business page 100. The user may be provided with the option of being navigated to the business webpage 100. The user may find out more information about the business through the business webpage 100. Information included may consist of hours of operation, services or products provided, contact information, and payment methods. Additionally, the business page 100 may provide the user with the option of scheduling an appointment.

In yet another embodiment of the present invention, it is contemplated that the participating businesses must pass a series of qualifications to be included in the plurality of participating businesses stored in the database 20 for customer review. The qualifications may include but are not limited to: verification via Dunn and Bradstreet report, the amount of years in business, membership in the better business bureau and minimum facility requirements associated with a particular industry. Additionally, a participating business included in the database may be required to maintain a threshold minimum customer satisfaction index score 50. For example, the customer satisfaction index may range between 0% and 100%. If the participating business is not able to maintain a 65% customer satisfaction index score 50, the participating business may be removed from the database and prevented from participating in search results. Other criteria used to obtain membership as a participating business includes an approved business management system and annual audits.

Furthermore, the various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention.

What is claimed is:

1. A method of displaying business information, the method comprising:
storing a set of business information in a database relating to a plurality of businesses;
collecting customer satisfaction information related to the plurality of businesses;
inputting the collected customer satisfaction information into the database;
correlating the collected customer satisfaction information to the plurality of businesses;
receiving a search query and generating a responsive data subset;
sorting the data subset using at least geographic location information; and
displaying the sorted data subset on a webpage, the sorted data subset being representative of a listing of businesses wherein each business listed from the plurality of businesses having corresponding customer satisfaction information.

2. The method of claim 1, wherein the database is in communication with the plurality of businesses for receiving customer business information.

3. The method of claim 1, wherein collecting customer satisfaction information is obtained via a telephone communication.

4. The method of claim 1, wherein collecting customer satisfaction information is obtained via an email communication.

5. The method of claim 1, wherein collecting customer satisfaction information is obtained via a website.

6. The method of claim 1, further comprising a web server for receiving the search query via a web browser.

7. The method of claim 6, wherein the web server having a software application for generating the responsive data subset in response to receiving the search query.

8. The method of claim 7, wherein the software application is configured to sort the data subset using at least geographic location information.

9. The method of claim 7, wherein the software application is configured to format the sorted data subset for displaying on the webpage.

10. The method of claim 7, wherein the software application is configured to calculate a customer service index score based upon the collected customer satisfaction information.

11. The method of claim 6, wherein the web server hosts the database.

12. A system for displaying businesses information, the system comprising:
a database for storing a set of business information in a database relating to a plurality of businesses, the database being configured to store customer satisfaction information;
a software application hosted on the database for collecting customer business information from the plurality of businesses; and
a web server for receiving a search query from a web browser, the web server being configured to generate a data subset responsive to the search query, the data subset being representative of a list of businesses from the plurality of businesses, the data subset including customer satisfaction information corresponding to each business within the list of businesses, the web server being configured to sort the data subset using at least geographic location information.

13. The system of claim 12, wherein the software application is configured to calculate a customer satisfaction index score for each business from the plurality of businesses based upon the customer satisfaction information.

14. The system of claim 12, wherein the software application is configured to receive customer business information from the plurality of businesses.
